(19) United States
(12) Patent Application Publication
(10) Pub. No.: US 2022/0141071 A1
(43) Pub. Date: May 5, 2022

(54) TERMINAL APPARATUS, BASE STATION APPARATUS, AND COMMUNICATION METHOD

(71) Applicants: SHARP KABUSHIKI KAISHA, Sakai City, Osaka (JP); FG Innovation Company Limited, Tuen Mun, New Territories (HK)

(72) Inventors: HIDEO NAMBA, Sakai City, Osaka (JP); HIROMICHI TOMEBA, Sakai City, Osaka (JP); TAKASHI ONODERA, Sakai City, Osaka (JP); YASUHIRO HAMAGUCHI, Sakai City, Osaka (JP); FUMIAKI MAEHARA, Tokyo (JP)

(21) Appl. No.: 17/433,771

(22) PCT Filed: Feb. 4, 2020
(86) PCT No.: PCT/JP2020/004167

§ 371 Date: Aug. 25, 2021

(30) Foreign Application Priority Data
Feb. 28, 2019 (JP) 2019-035930

(51) Int. Cl. H04L 27/26; H04L 5/00; H04W 52/22

(52) U.S. Cl. CPC H04L 27/2634; H04W 52/228; H04L 5/001

(57) ABSTRACT

In a communication scheme using a radio frame used in a mobile communication system, a reduction in transmission efficiency that occurs in a case of performing Listen Before Talk (LBT) that performs carrier sense for transmission is relieved. An OFDM signal generated in a terminal apparatus includes any of a first OFDM signal including a signal resulting from inverse discrete Fourier transform and a cyclic prefix (CP) using a portion of the signal resulting from the inverse discrete Fourier transform, and a second OFDM signal obtained by replacing a partial segment of the first OFDM signal with a prescribed number of continuous zeros, a transmission signal is managed with a resource grid of which a unit includes one or more subcarriers and an OFDM symbol length including the CP, and in a case that a period between the transmission occasion based on the carrier sense and the boundary of the resource grid is less than or equal to a prescribed time, the second OFDM signal is transmitted.

### TECHNICAL FIELD

The present invention relates to a terminal apparatus, a base station apparatus, and a communication method. This application claims priority based on JP 2019-35930 filed on Feb. 28, 2019, the contents of which are incorporated herein by reference.

### BACKGROUND ART

Mobile communication system in which digital conversion has progressed since the 1990s has become increasingly sophisticated over the years, and in the fourth generation mobile communication system which has been introduced from around 2010, a method of simultaneously using multiple cells of different frequencies has been introduced on a large scale, thus causing the communication speed to increase. For further utilization of broadband, a method has been studied that utilizes so-called industry science and medical (ISM) bands, and the like for the mobile communication system, which are different from frequencies allocated for the mobile communication system and are usable without licenses, and in the 3rd Generation Partnership Project (3GPP), the standardization has progressed in releases including and after Release-13 (NPL 1).

### CITATION LIST

### Non Patent Literature

NPL 1: “3rd Generation Partnership Project; Technical Specification Group Radio Access Network; Evolved Universal Terrestrial Radio Access (E-UTRA); Physical layer procedures (Release 13)”, 3rd Generation Partnership Project, September 2016

### SUMMARY OF INVENTION

### Technical Problem

However, the frequency band that can be used without license often requires so-called Listen Before Talk (LBT), which carries out carrier sense for transmission, and there is a possibility that transmission efficiency may be reduced in a case of being combined with a method using a radio frame used in a mobile communication system.

An aspect of the present invention has been made in view of such circumstances, and an object of the present invention is to provide a terminal apparatus and a communication method that improve efficiency reduction in a case that a method using a radio frame and a transmission method using carrier sense are combined.

### Solution to Problem

To solve the above-mentioned problem, a base station apparatus, a terminal apparatus, and a communication method according to an aspect of the present invention are configured as follows.

(1) In order to achieve the above-described object, according to an aspect of the present invention, there is provided a terminal apparatus for communicating with a base station apparatus, the terminal apparatus including: a transmitter configured to transmit an Orthogonal Frequency Division Multiplexing (OFDM) signal; a receiver configured to receive a control signal transmitted from the base station apparatus and perform carrier sense; and a controller configured to control generation of the OFDM signal and a transmission start timing, wherein the OFDM signal includes any of a first OFDM signal including a signal resulting from inverse discrete Fourier transform and a cyclic prefix (CP) using a portion of the signal resulting from the inverse discrete Fourier transform, and a second OFDM signal obtained by replacing a partial segment of the first OFDM signal with a prescribed number of continuous zeros, the controller manages a transmission signal with a resource grid of which a unit includes one or more subcarriers and a symbol length of the first OFDM signal, and in a case that a transmission occasion based on a carrier sense performed by the receiver is different from a boundary of the resource grid, and in a case that a period between the transmission occasion based on the carrier sense and the boundary of the resource grid is less than or equal to a prescribed time, the second OFDM signal is controlled to be transmitted.

(2) In order to achieve the above-described object, according to an aspect of the present invention, there is provided the terminal apparatus in which the controller configures a scheme used for coding and a scheme used for modulation, the scheme used for the coding and the scheme used for the modulation are specified as an MCS, the transmitter codes and modulates uplink data, based on the MCS for one or more subcarriers included in the first OFDM signal or the second OFDM signal, and the controller further controls the second OFDM signal to be transmitted in a case that the MCS is lower than a prescribed value.

(3) In order to achieve the above-described object, according to an aspect of the present invention, there is provided the terminal apparatus in which the partial segment replaced by zeros for the second OFDM signal is selected from one or more candidate values.

(4) In order to achieve the above-described object, according to an aspect of the present invention, there is provided the terminal apparatus in which a transmit power of the second OFDM signal is greater than a transmit power of the first OFDM signal.

(5) In order to achieve the above-described object, according to an aspect of the present invention, there is provided the terminal apparatus in which the controller is capable of selecting whether a precoding process using a discrete Fourier transform is applied to an input of the inverse discrete Fourier transform, and in a case that the precoding process is not applied, the second OFDM signal is controlled to be transmitted.

(6) In order to achieve the above-described object, according to an aspect of the present invention, there is provided the terminal apparatus in which a configuration unit of the resource grid is a resource block, the transmitter codes and modulates uplink data for one or more subcarriers included in the first OFDM signal or the second OFDM signal, and the controller controls the second OFDM signal to be transmitted based on the number of resource blocks for transmitting the one or more subcarriers in a frequency domain.

(7) In order to achieve the above-described object, according to an aspect of the present invention, there is provided the terminal apparatus in which the controller generates control information to be transmitted to the base station apparatus, and the control information includes information for indicating that the terminal apparatus is capable of generating the second OFDM signal.

(8) In order to achieve the above-described object, according to an aspect of the present invention, there is provided the terminal apparatus in which in a case that the control information transmitted from the base station apparatus and received by the receiver includes information for indicating that the base station apparatus supports the second OFDM signal, the controller controls the second OFDM signal to be transmitted.

(9) In order to achieve the above-described object, according to an aspect of the present invention, there is provided the terminal apparatus in which the transmitter causes a transmit power of a segment which is replaced by zeros in the second OFDM signal to be less than a transmit power of a segment which is not replaced by zeros in the second OFDM signal.

(10) In order to achieve the above-described object, according to an aspect of the present invention, there is provided a base station apparatus for communicating with a terminal apparatus, the base station apparatus including: a receiver configured to receive a signal transmitted from the terminal apparatus; and a controller configured to control a control signal, wherein the terminal apparatus transmits any of a first OFDM signal including a signal resulting from inverse discrete Fourier transform and a cyclic prefix (CP) using a portion of the signal resulting from the inverse discrete Fourier transform, and a second OFDM signal obtained by replacing a partial segment of the first OFDM signal with a prescribed number of continuous zeros, the receiver receives information for indicating that generation of the second OFDM signal is enabled in a control signal transmitted from the terminal apparatus, and receives the second OFDM signal transmitted by the terminal apparatus.

(11) In order to achieve the above-described object, according to an aspect of the present invention, there is provided a communication method including: receiving a control signal transmitted from a base station apparatus; performing carrier sense; and controlling generation of an OFDM signal and a transmission start timing, wherein the generated OFDM signal includes any of a first OFDM signal including a signal resulting from inverse discrete Fourier transform and a cyclic prefix (CP) using a portion of the signal resulting from the inverse discrete Fourier transform, and a second OFDM signal obtained by replacing a partial segment of the first OFDM signal with a prescribed number of continuous zeros, a transmission signal is managed with a resource grid of which a unit includes one or more subcarriers and an OFDM symbol length including the CP, and in a case that a transmission occasion based on a result of the carrier sense is different from a boundary of the resource grid, and in a case that a period between the transmission occasion based on the carrier sense and the boundary of the resource grid is less than or equal to a prescribed time, the second OFDM signal is transmitted.

### Advantageous Effects of Invention

According to an aspect of the present invention, in a case that a period between a transmission occasion based on carrier sense and a boundary of a resource grid is less than or equal to a prescribed time, by transmitting an OFDM signal in which a portion of the OFDM signal to which the cyclic prefix has been added is replaced with zeros, it is possible to improve transmission efficiency in a case that the transmission occasion based on carrier sense is different from the boundary of the resource grid.

### BRIEF DESCRIPTION OF DRAWINGS

FIG. 1 is a diagram illustrating an example of a communication system according to the present embodiment.

FIG. 2 is a block diagram illustrating a configuration example of a base station apparatus according to the present embodiment.

FIG. 3 is a block diagram illustrating a configuration example of a terminal apparatus according to the present embodiment.

FIG. 4 is a diagram illustrating an example of a communication system according to the present embodiment.

FIG. 5 is a diagram illustrating an example of a communication system according to the present embodiment.

FIG. 6 is a diagram illustrating an example of OFDM signals according to the present embodiment.

FIG. 7 is a diagram illustrating an example of radio resources according to the present embodiment.

### DESCRIPTION OF EMBODIMENTS

A communication system according to the present embodiment includes a base station apparatus (a transmitting apparatus, cells, a transmission point, a group of transmit antennas, a group of transmit antenna ports, component carriers, an eNodeB, a transmission point, a transmission and/or reception point, a transmission panel, an access point, a subarray, and a Band Width Part (BWP)), and terminal apparatuses (a terminal, a mobile terminal, a reception point, a reception terminal, a receiver, a group of receive antennas, a group of receive antenna ports, a UE, a reception point, a reception panel, a station, and a subarray). Furthermore, a base station apparatus connected to a terminal apparatus (base station apparatus that establishes a radio link with a terminal apparatus) is referred to as a serving cell. Note that the BWP indicates a part of bandwidth of the system bandwidth.

The base station apparatus and the terminal apparatus in the present embodiment can communicate in a licensed band and/or an unlicensed band.

According to the present embodiment, “X/Y” includes the meaning of “X or Y”. According to the present embodiment, “X/Y” includes the meaning of “X and Y”. According to the present embodiment, “X/Y” includes the meaning of “X and/or Y”.

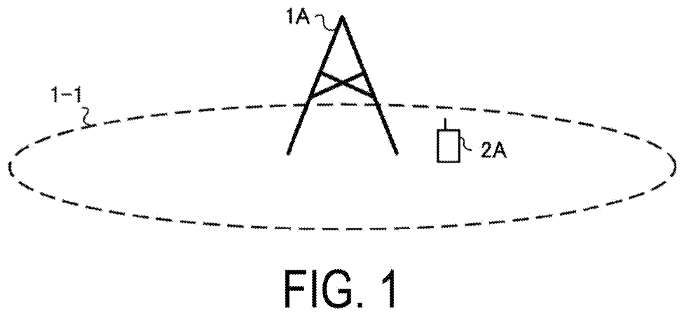

FIG. 1 is a diagram illustrating an example of a communication system according to the present embodiment. As illustrated in FIG. 1, the communication system according to the present embodiment includes a base station apparatus 1A and a terminal apparatus 2A. Coverage 1-1 is a range (a communication area) in which the base station apparatus 1A can connect to the terminal apparatus 2A. The base station apparatus 1A is also simply referred to as a base station apparatus. The terminal apparatus 2A is also simply referred to as a terminal apparatus.

With respect to FIG. 1, the following uplink physical channels are used for uplink radio communication from the terminal apparatus 2A to the base station apparatus 1A. The uplink physical channels are used to transmit information output from a higher layer.
Physical Uplink Control Channel (PUCCH)
Physical Uplink Shared Channel (PUSCH)
Physical Random Access Channel (PRACH)

The PUCCH is used to transmit Uplink Control Information (UCI). The Uplink Control Information includes a positive ACKnowledgement (ACK) or a Negative ACKnowledgement (NACK) (ACK/NACK) for downlink data (a downlink transport block or a Downlink-Shared Channel (DL-SCH)). ACK/NACK for the downlink data is also referred to as HARQ-ACK or HARQ feedback.

Here, the Uplink Control Information includes Channel State Information (CSI) for the downlink. The Uplink Control Information includes a Scheduling Request (SR) used to request an Uplink-Shared Channel (UL-SCH) resource. The Channel State Information refers to a Rank Indicator (RI) for specifying a preferable spatial multiplexing order, a Precoding Matrix Indicator (PMI) for specifying a preferable precoder, a Channel Quality Indicator (CQI) for specifying a preferable transmission rate, a CSI-Reference Signal (RS) Resource Indicator (CSI-RS Resource Indicator) (CRI) for specifying a preferable CSI-RS resource, a Reference Signal Received Power (RSRP) measured by a CSI-RS or a Synchronization Signal (SS), and the like.

The Channel Quality Indicator CQI (hereinafter, referred to as a CQI value) can be a preferable modulation scheme (e.g., QPSK, 16QAM, 64QAM, 256QAM, or the like) and a preferable coding rate in a prescribed band (details of which will be described later). The CQI value can be an index (CQI Index) determined by the above modulation scheme, coding rate, and the like. The CQI value can take a value predetermined in the system.

The CRI indicates a CSI-RS resource whose received power/received quality is suitable from multiple CSI-RS resources.

Note that the Rank Indicator and the Precoding Quality Indicator can take the values predetermined in the system. The Rank Indicator and the Precoding Matrix Indicator can be an index determined by the spatial multiplexing order and Precoding Matrix information. Note that some or all of the CQI value, the PMI value, the RI value, and the CRI value are also collectively referred to as “CSI values”.

PUSCH is used for transmission of uplink data (an uplink transport block, UL-SCH). Furthermore, PUSCH may be used for transmission of ACK/NACK and/or Channel State Information along with the uplink data. In addition, PUSCH may be used to transmit the uplink control information only.

PUSCH is used to transmit an RRC message. The RRC message is a signal/information that is processed in a Radio Resource Control (RRC) layer. Further, PUSCH is used to transmit an MAC Control Element (CE). Here, MAC CE is a signal/information that is processed (transmitted) in a Medium Access Control (MAC) layer.

For example, a power headroom may be included in the MAC CE and may be reported via the PUSCH. In other words, a MAC CE field may be used to indicate a level of the power headroom.

The PRACH is used to transmit a random access preamble.

In the uplink radio communication, an Uplink Reference Signal (UL RS) is used as an uplink physical signal. The uplink physical signal is not used for transmission of information output from higher layers, but is used by the physical layer. Here, the uplink reference signal includes a Demodulation Reference Signal (DMRS), a Sounding Reference Signal (SRS), and a Phase-Tracking reference signal (PT-RS).

The DMRS is associated with transmission of the PUSCH or the PUCCH. For example, the base station apparatus 1A uses the DMRS in order to perform channel compensation of the PUSCH or the PUCCH. For example, the base station apparatus 1A uses SRS to measure an uplink channel state. The SRS is used for uplink observation (sounding). The PT-RS is used to compensate for phase noise. Note that a DMRS of the uplink is also referred to as an uplink DMRS.

In FIG. 1, the following downlink physical channels are used for the downlink radio communication from the base station apparatus 1A to the terminal apparatus 2A. The downlink physical channels are used to transmit information output from the higher layer.
Physical Broadcast Channel (PBCH)
Physical Control Format Indicator Channel (PCFICH)
Physical Hybrid automatic repeat request Indicator Channel (PHICH)
Physical Downlink Control Channel (PDCCH)
Enhanced Physical Downlink Control Channel (EPDCCH)
Physical Downlink Shared Channel (PDSCH)

The PBCH is used to broadcast a Master Information Block (MIB, a Broadcast Channel (BCH)) that is used commonly by terminal apparatuses 2A. PCFICH is used for transmission of information for indicating a region (e.g., the number of Orthogonal Frequency Division Multiplexing (OFDM) symbols) to be used for transmission of PDCCH. Note that the MIB is also referred to as minimum system information.

PHICH is used for transmission of ACK/NACK with respect to uplink data (a transport block, a codeword) received by the base station apparatus 1A. In other words, PHICH is used for transmission of a HARQ indicator (HARQ feedback) for indicating ACK/NACK with respect to the uplink data. Note that ACK/NACK is also called HARQ-ACK. The terminal apparatus 2A reports ACK/NACK having been received to a higher layer. ACK/NACK refers to ACK for indicating a successful reception, NACK for indicating an unsuccessful reception, and DTX for indicating that no corresponding data is present. In a case that PHICH for uplink data is not present, the terminal apparatus 2A reports ACK to a higher layer.

The PDCCH and the EPDCCH are used to transmit Downlink Control Information (DCI). Here, multiple DCI formats are defined for transmission of the downlink control information. To be more specific, a field for the downlink control information is defined in a DCI format and is mapped to information bits.

For example, as a DCI format for the downlink, DCI format 1A to be used for the scheduling of one PDSCH in one cell (transmission of a single downlink transport block) is defined.

For example, the DCI format for the downlink includes downlink control information such as information of PDSCH resource allocation, information of a Modulation and Coding Scheme (MCS) for PDSCH, and a transmit power Control (TPC) command for PUCCH. Here, the DCI format for the downlink is also referred to as downlink grant (or downlink assignment).

Furthermore, for example, as a DCI format for the uplink, DCI format 0 to be used for the scheduling of one PUSCH in one cell (transmission of a single uplink transport block) is defined.

For example, the DCI format for the uplink includes uplink control information such as information of PUSCH resource allocation, information of MCS for PUSCH, and a TPC command for PUSCH. Here, the DCI format for the uplink is also referred to as uplink grant (or uplink assignment).

Furthermore, the DCI format for the uplink can be used to request Channel State Information (CSI; also referred to as received quality information) for the downlink (CSI request).

The DCI format for the uplink can be used for a configuration for indicating an uplink resource to which a CSI feedback report is mapped, the CSI feedback report being fed back to the base station apparatus 1A by the terminal apparatus 2A. For example, the CSI feedback report can be used for a configuration for indicating an uplink resource that periodically reports Channel State Information (periodic CSI). The CSI feedback report can be used for a mode configuration (CSI report mode) for periodically reporting the Channel State Information.

For example, the CSI feedback report can be used for a configuration for indicating an uplink resource that reports aperiodic Channel State Information (aperiodic CSI). The CSI feedback report can be used for a mode configuration (CSI report mode) for aperiodically reporting the Channel State Information.

For example, the CSI feedback report can be used for a configuration for indicating an uplink resource that reports semi-persistent Channel State Information (semi-persistent CSI). The CSI feedback report can be used for a mode configuration (CSI report mode) for semi-persistently reporting the Channel State Information. Note that the semi-persistent CSI feedback report is to periodically report channel state information during a period of time since activation is performed with higher layer signaling or downlink control information until deactivation.

The DCI format for the uplink can be used for a configuration for indicating a type of the CSI feedback report that is fed back to the base station apparatus 1A by the terminal apparatus 2A. The type of the CSI feedback report includes wideband CSI (e.g., Wideband CQI), narrowband CSI (e.g., Subband CQI), and the like.

In a case that a PDSCH resource is scheduled in accordance with the downlink assignment, the terminal apparatus 2A receives downlink data on the scheduled PDSCH. In a case that a PUSCH resource is scheduled in accordance with the uplink grant, the terminal apparatus 2A transmits uplink data and/or uplink control information on the scheduled PUSCH.

The PDSCH is used to transmit the downlink data (the downlink transport block, DL-SCH). PDSCH is used to transmit a system information block type 1 message. The system information block type 1 message is cell-specific information.

The PDSCH is used to transmit a system information message. The system information message includes a system information block X other than the system information block type 1. The system information message is cell-specific information.

The PDSCH is used to transmit an RRC message. Here, the RRC message transmitted from the base station apparatus 1A may be shared by multiple terminal apparatuses 2A in a cell. Further, the RRC message transmitted from the base station apparatus 1A may be a dedicated message to a certain terminal apparatus 2A (also referred to as dedicated signaling). In other words, user equipment specific (user equipment unique) information is transmitted by using the message dedicated to the certain terminal apparatus 2A. PDSCH is used to transmit MAC CE.

Here, the RRC message and/or MAC CE is also referred to as higher layer signaling.

The PDSCH can be used to request downlink channel state information. The PDSCH can be used for transmission of an uplink resource to which a CSI feedback report is mapped, the CSI feedback report being fed back to the base station apparatus 1A by the terminal apparatus 2A. For example, the CSI feedback report can be used for a configuration for indicating an uplink resource that periodically reports Channel State Information (periodic CSI). The CSI feedback report can be used for a mode configuration (CSI report mode) for periodically reporting the Channel State Information.

The type of the downlink CSI feedback report includes wideband CSI (e.g., Wideband CSI) and narrowband CSI (e.g., Subband CSI). The wideband CSI calculates one piece of Channel State Information for the system band of a cell. The narrowband CSI divides the system band in prescribed units, and calculates one piece of Channel State Information for each division.

In the downlink radio communication, a Synchronization Signal (SS) and a Downlink Reference Signal (DL RS) are used as downlink physical signals. The downlink physical signals are not used to transmit information output from the higher layers, but are used by the physical layer. Note that synchronization signals include a Primary Synchronization Signal (PSS) and a Secondary Synchronization Signal (SSS).

The synchronization signals are used for the terminal apparatus 2A to take synchronization of the downlink in the frequency domain and the time domain. The synchronization signals are used to measure received power, received quality, or Signal-to-Interference and Noise power Ratio (SINR). Note that a received power measured by a synchronization signal is also referred to as a Synchronization Signal-Reference Signal Received Power (SS-RSRP), a received quality measured by a synchronization signal is also referred to as a Reference Signal Received Quality (SS-RSRQ), and an SINR measured by a synchronization signal is also referred to as an SS-SINR. Note that an SS-RSRQ is a ratio between an SS-RSRP and an RSSI. The Received Signal Strength Indicator (RSSI) is the total average received power for a certain observation period. The synchronization signals/downlink reference signals are used for the terminal apparatus 2A to perform channel compensation on a downlink physical channel. For example, the synchronization signals/downlink reference signals are used for the terminal apparatus 2A to calculate the downlink Channel State Information.

Here, the downlink reference signals include a Demodulation Reference Signal (DMRS), a Non-Zero Power Channel State Information-Reference Signal (NZP CSI-RS), a Zero Power Channel State Information-Reference Signal (ZP CSI-RS), a PT-RS, and a Tracking Reference Signal (TRS). Note that a DMRS of the downlink is also referred to as a downlink DMRS. Note that in the following embodiments, simply referring to a CSI-RS includes an NZP CSI-RS and/or ZP CSI-RS.

The DMRS is transmitted in a subframe and a band that are used for transmission of PDSCH/PBCH/PDCCH/EPDCCH to which the DMRS relates, and is used to demodulate PDSCH/PBCH/PDCCH/EPDCCH to which the DMRS relates.

A resource for NZP CSI-RS is configured by the base station apparatus 1A. For example, the terminal apparatus 2A performs signal measurement (channel measurement) or interference measurement by using NZP CSI-RS. The NZP CSI-RS is used for beam recovery or the like for recovering in a case that the received power/received quality in the beam scanning or beam direction seeking a suitable beam direction deteriorates. A resource for ZP CSI-RS is configured by the base station apparatus 1A. With zero output, the base station apparatus 1A transmits ZP CSI-RS. The terminal apparatus 2A performs interference measurement in a resource to which ZP CSI-RS corresponds, for example. Note that a resource for interference measurement corresponding to ZP CSI-RS is also referred to as a CSI-Interference Measurement (IM) resource.

The base station apparatus 1A transmits (configures) an NZP CSI-RS resource configuration for the resource of the NZP CSI-RS. The NZP CSI-RS resource configuration includes some or all of one or more NZP CSI-RS resource mappings, a CSI-RS resource configuration ID for each NZP CSI-RS resource, and the number of antenna ports. The CSI-RS resource mapping is information indicating an OFDM symbol and a subcarrier (e.g., a resource element) in a slot to which the CSI-RS resource is allocated. The CSI-RS resource configuration ID is used to identify the NZP CSI-RS resource.

The base station apparatus 1A transmits (configures) a CSI-IM resource configuration. The CSI-IM resource configuration includes one or more CSI-IM resource mappings, and a CSI-IM resource configuration ID for each CSI-IM resource. The CSI-IM resource mapping is information indicating an OFDM symbol and a subcarrier (e.g., a resource element) in a slot to which the CSI-IM resource is allocated. The CSI-IM resource configuration ID is used to identify the CSI-IM configuration resource.

The CSI-RS is also used to measure the received power, the received quality, or the SINR. The received power measured by the CSI-RS is also referred to as a CSI-RSRP, the received quality measured by the CSI-RS is also referred to as a CSI-RSRQ, and the SINR measured by the CSI-RS is also referred to as a CSI-SINR. Note that the CSI-RSRQ is a ratio between a CSI-RSRP and an RSSI.

The CSI-RS is transmitted periodically/non-periodically/semi-persistently.

The terminal apparatus 2A is configured by a higher layer with respect to CSI. For example, such a configuration includes a report configuration that is a configuration of a CSI report, a resource configuration that is a configuration of a resource for measuring CSI, and a measurement link configuration for linking a report configuration and a resource configuration for CSI measurement. One or more report configurations, resource configurations, and measurement link configurations are configured.

The report configuration includes some or all of a report configuration ID, a report configuration type, a codebook configuration, a CSI report amount, a block error rate target. The report configuration ID is used to identify a report configuration. The report configuration type indicates a periodic/non-periodic/semi-persistent CSI report. The CSI report amount indicates the amount to report (value, type), e.g., some or all of CRI, RI, PMI, CQI, and RSRP. The block error rate target is a target of block error rate that is assumed in computing the CQI.

The resource configuration includes some or all of a resource configuration ID, a synchronization signal block resource measurement list, a resource configuration type, and one or more resource set configurations. The resource configuration ID is used to identify a resource configuration. The synchronization signal block resource configuration list is a list of resources for which measurements are made using synchronization signals. The resource configuration type indicates whether the CSI-RS is transmitted periodically, non-periodically, or semi-persistently. Note that in the case of a configuration in which the CSI-RS is transmitted semi-persistently, the CSI-RS is periodically transmitted during a period of time since activation is performed with higher layer signaling or downlink control information until deactivation.

The resource set configuration includes some or all of a resource set configuration ID, resource repetition, and information indicating one or more CSI-RS resources. The resource set configuration ID is used to identify a resource set configuration. The resource repetition indicates the on/off of resource repetition within the resource set. In a case that the resource repetition is on, the base station apparatus 1A is meant to use a fixed (identical) transmission beam for each of multiple CSI-RS resources in the resource set. In other words, in a case that the resource repetition is on, the terminal apparatus 2A assumes that the base station apparatus 1A uses a fixed (identical) transmission beam for each of multiple CSI-RS resources in the resource set. In a case that the resource repetition is off, the base station apparatus 1A is meant not to use a fixed (identical) transmission beam for each of multiple CSI-RS resources in the resource set. In other words, in a case that the resource repetition is off, the terminal apparatus 2A assumes that the base station apparatus 1A does not use a fixed (identical) transmission beam for each of multiple CSI-RS resources in the resource set. The information indicating the CSI-RS resource includes one or more CSI-RS resource configuration IDs, and one or more CSI-IM resource configuration IDs.

The measurement link configuration includes some or all of a measurement link configuration ID, a report configuration ID, and a resource configuration ID, and the report configuration and the resource configuration are linked. The measurement link configuration ID is used to identify a measurement link configuration.

A Multimedia Broadcast multicast service Single Frequency Network (MBSFN) RS is transmitted in an entire band of the subframe used for transmitting PMCH. MBSFN RS is used to demodulate PMCH. PMCH is transmitted through the antenna port used for transmission of MBSFN RS.

Here, the downlink physical channel and the downlink physical signal are also collectively referred to as a downlink signal. In addition, the uplink physical channel and the uplink physical signal are also collectively referred to as an uplink signal. In addition, the downlink physical channel and the uplink physical channel are also collectively referred to as a physical channel. In addition, the downlink physical signal and the uplink physical signal are also collectively referred to as a physical signal.

BCH, UL-SCH, and DL-SCH are transport channels. Channels used in the MAC layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing and the like are performed for each codeword.

Furthermore, for the terminal apparatus 2A that supports Carrier Aggregation (CA), the base station apparatus 1A can integrate multiple Component Carriers (CCs) for transmission in a broader band to perform communication. In carrier aggregation, one Primary Cell (PCell) and one or more Secondary Cells (SCells) are configured as a set of serving cells.

Furthermore, in Dual Connectivity (DC), a Master Cell Group (MCG) and a Secondary Cell Group (SCG) are configured as a group of serving cells. MCG includes a PCell and optionally one or more SCells. Furthermore, SCG includes a primary SCell (PSCell) and optionally one or more SCells.

The base station apparatus 1A can communicate by using a radio frame. The radio frame includes multiple subframes (sub-periods). In a case that a frame length is expressed in time, for example, a radio frame length can be 10 milliseconds (ms), and a subframe length can be 1 ms. In this example, the radio frame includes 10 subframes.

The slot includes 14 OFDM symbols. Because the OFDM symbol length can vary depending on the subcarrier spacing, the slot length can also vary with the subcarrier spacing. A mini-slot includes OFDM symbols fewer than those of a slot. The slot/mini-slot can be used as a scheduling unit. Note that the terminal apparatus can know the slot based scheduling/mini-slot based scheduling by the position (configuration) of the first downlink DMRS. In the slot based scheduling, the first downlink DMRS is allocated to the third or fourth symbol of the slot. In the mini-slot based scheduling, the first downlink DMRS is allocated to the first symbol of the scheduled data (resource, PDSCH).

A resource block is defined by 12 continuous subcarriers. A resource element is defined by an index of the frequency domain (e.g., a subcarrier index) and an index of the time domain (e.g., OFDM symbol index). The resource element is classified as an uplink resource element, a downlink element, a flexible resource element, and a reserved resource element. In the reserved resource element, the terminal apparatus 2A does not transmit an uplink signal and does not receive a downlink signal.

Multiple Subcarrier spacings (SCSs) are supported. For example, the SCSs include 15/30/60/120/240/480 kHz.

The base station apparatus 1A/terminal apparatus 2A can communicate with a licensed band or an unlicensed band. The base station apparatus 1A/terminal apparatus 2A can communicate with a licensed band serving as a PCell and performing carrier aggregation with at least one SCell operating in an unlicensed band. The base station apparatus 1A/terminal apparatus 2A can communicate in dual connectivity in which a master cell group communicates in a licensed band and a secondary cell group communicates in an unlicensed band. The base station apparatus 1A/terminal apparatus 2A can communicate with only a PCell in an unlicensed band. The base station apparatus 1A/terminal apparatus 2A can communicate with CA or DC only in an unlicensed band. Note that communication in which a licensed band serves as a PCell and assists a cell in an unlicensed band (SCell, PSCell), for example, by CA, DC, or the like, is also referred to as a Licensed-Assisted Access (LAA). Communication in which the base station apparatus 1A/terminal apparatus 2A only communicates with an unlicensed band is also referred to as Unlicensed-standalone access (ULSA). Communication in which the base station apparatus 1A/terminal apparatus 2A only communicates with a licensed band is also referred to as Licensed Access (LA).

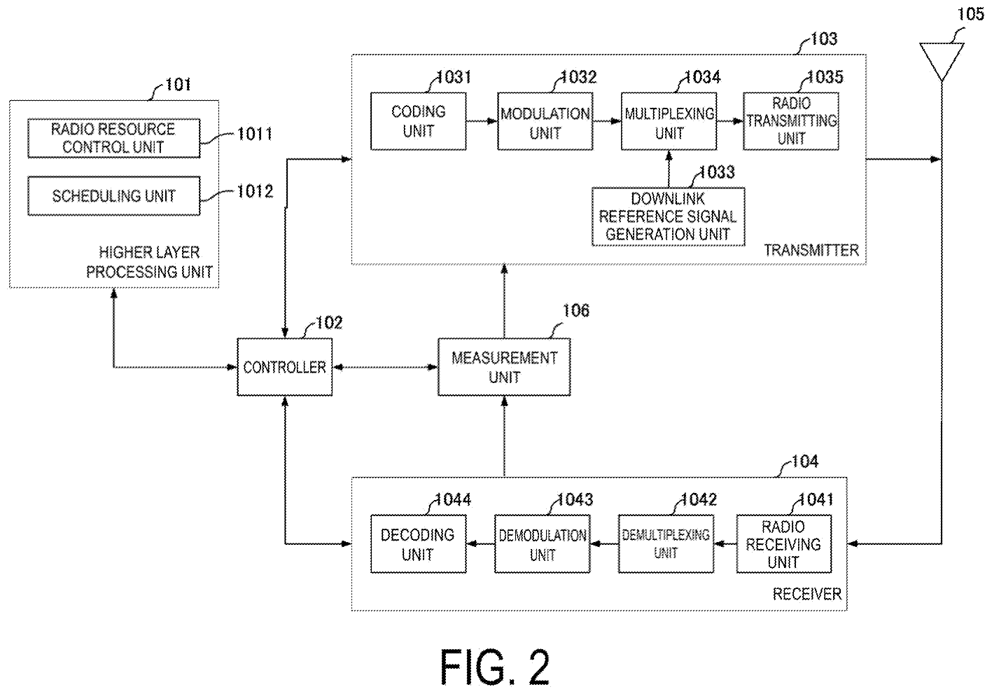

FIG. 2 is a schematic block diagram illustrating a configuration of the base station apparatus 1A according to the present embodiment. As illustrated in FIG. 2, the base station apparatus 1A includes a higher layer processing unit (higher layer processing step) 101, a controller (controlling step) 102, a transmitter (transmitting step) 103, a receiver (receiving step) 104, a transmit and/or receive antenna 105, and a measurement unit (measuring step) 106. The higher layer processing unit 101 includes a radio resource control unit (radio resource controlling step) 1011 and a scheduling unit (scheduling step) 1012. The transmitter 103 includes a coding unit (coding step) 1031, a modulation unit (modulating step) 1032, a downlink reference signal generation unit (downlink reference signal generating step) 1033, a multiplexing unit (multiplexing step) 1034, and a radio transmitting unit (radio transmitting step) 1035. The receiver 104 includes a radio receiving unit (radio receiving step) 1041, a demultiplexing unit (demultiplexing step) 1042, a demodulation unit (demodulating step) 1043, and a decoding unit (decoding step) 1044.

The higher layer processing unit 101 performs processing of a Medium Access Control (MAC) layer, a Packet Data Convergence Protocol (PDCP) layer, a Radio Link Control (RLC) layer, and a Radio Resource Control (RRC) layer. Furthermore, the higher layer processing unit 101 generates information necessary for control of the transmitter 103 and the receiver 104, and outputs the generated information to the controller 102.

The higher layer processing unit 101 receives information of the terminal apparatus 2A, such as a capability of the terminal apparatus 2A (UE capability), from the terminal apparatus 2A. To rephrase, the terminal apparatus 2A transmits its function to the base station apparatus 1A by higher layer signaling.

Note that in the following description, information of the terminal apparatus 2A includes information for indicating whether the terminal apparatus 2A supports a prescribed function, or information for indicating that the terminal apparatus 2A has completed the introduction and test of a prescribed function. In the following description, information of whether the prescribed function is supported includes information of whether the introduction and test of the prescribed function have been completed.

For example, in a case that the terminal apparatus 2A supports a prescribed function, the terminal apparatus 2A transmits information (parameters) for indicating whether the prescribed function is supported. In a case that the terminal apparatus 2A does not support a prescribed function, the terminal apparatus 2A does not transmit information (parameters) for indicating whether the prescribed function is supported. In other words, whether the prescribed function is supported is notified by whether information (parameters) for indicating whether the prescribed function is supported is transmitted. Note that the information (parameter) for indicating whether the prescribed function is supported may be notified by using one bit of 1 or 0.

The radio resource control unit 1011 generates, or acquires from a higher node on the core network connected to the base station apparatus 1A, the downlink data (the transport block) allocated in the downlink PDSCH, system information, the RRC message, the MAC CE, and the like. The radio resource control unit 1011 outputs the downlink data to the transmitter 103, and outputs other information to the controller 102. Furthermore, the radio resource control unit 1011 manages various configuration information of the terminal apparatuses 2A.

The scheduling unit 1012 determines a frequency and a subframe to which the physical channels (PDSCH and PUSCH) are allocated, the coding rate and modulation scheme (or MCS) for the physical channels (PDSCH and PUSCH), the transmit power, and the like. The scheduling unit 1012 outputs the determined information to the controller 102.

The scheduling unit 1012 generates information to be used for scheduling the physical channels (PDSCH and PUSCH), based on the result of the scheduling. The scheduling unit 1012 outputs the generated information to the controller 102.

Based on the information input from the higher layer processing unit 101, the controller 102 generates a control signal for controlling the transmitter 103 and the receiver 104. The controller 102 generates the downlink control information based on the information input from the higher layer processing unit 101, and outputs the generated information to the transmitter 103.

The transmitter 103 generates the downlink reference signal in accordance with the control signal input from the controller 102, codes and modulates the HARQ indicator, the downlink control information, and the downlink data that are input from the higher layer processing unit 101, multiplexes PHICH, PDCCH, EPDCCH, PDSCH, and the downlink reference signal, and transmits a signal obtained through the multiplexing to the terminal apparatus 2A through the transmit and/or receive antenna 105.

The coding unit 1031 codes the HARQ indicator, the downlink control information, and the downlink data that are input from the higher layer processing unit 101, in compliance with a predetermined coding scheme, such as block coding, convolutional coding, turbo coding, Low density parity check (LDPC) coding, and Polar coding, or in compliance with a coding scheme determined by the radio resource control unit 1011. The modulation unit 1032 modulates the coded bits input from the coding unit 1031, in compliance with the modulation scheme prescribed in advance, such as Binary Phase Shift Keying (BPSK), quadrature Phase Shift Keying (QPSK), quadrature amplitude modulation (16QAM), 64QAM, or 256QAM, or in compliance with the modulation scheme determined by the radio resource control unit 1011.

The downlink reference signal generation unit 1033 generates, as the downlink reference signal, a sequence, known to the terminal apparatus 2A, that is determined in accordance with a rule predetermined based on the physical cell identity (PCI, cell ID) for identifying the base station apparatus 1A, and the like.

The multiplexing unit 1034 multiplexes the modulated modulation symbol of each channel, the generated downlink reference signal, and the downlink control information. To be more specific, the multiplexing unit 1034 maps the modulated modulation symbol of each channel, the generated downlink reference signal, and the downlink control information to the resource elements.

The radio transmitting unit 1035 performs Inverse Fast Fourier Transform (IFFT) on the modulation symbol resulting from the multiplexing or the like, generates an OFDM symbol, adds a cyclic prefix (CP) to the generated OFDM symbol, generates a baseband digital signal, converts the baseband digital signal into an analog signal, removes unnecessary frequency components through filtering, up-converts a result of the removal into a signal of a carrier frequency, performs power amplification, and outputs a final result to the transmit and/or receive antenna 105 for transmission.

In accordance with the control signal input from the controller 102, the receiver 104 demultiplexes, demodulates, and decodes the reception signal received from the terminal apparatus 2A through the transmit and/or receive antenna 105, and outputs information resulting from the decoding to the higher layer processing unit 101.

The radio receiving unit 1041 converts, by down-converting, an uplink signal received through the transmit and/or receive antenna 105 into a baseband signal, removes unnecessary frequency components, controls the amplification level in such a manner as to suitably maintain a signal level, performs orthogonal demodulation based on an in-phase component and an orthogonal component of the received signal, and converts the resulting orthogonally-demodulated analog signal into a digital signal.

The radio receiving unit 1041 removes a portion corresponding to CP from the digital signal resulting from the conversion. The radio receiving unit 1041 performs Fast Fourier Transform (FFT) of the signal from which the CP has been removed, extracts a signal in the frequency domain, and outputs the resulting signal to the demultiplexing unit 1042.

The demultiplexing unit 1042 demultiplexes the signal input from the radio receiving unit 1041 into signals such as PUCCH, PUSCH, and uplink reference signal. Note that the demultiplexing is performed based on radio resource allocation information that is predetermined by the base station apparatus 1A by using the radio resource control unit 1011 and that is included in the uplink grant notified to each of the terminal apparatuses 2A.

Furthermore, the demultiplexing unit 1042 performs channel compensation for PUCCH and PUSCH. The demultiplexing unit 1042 demultiplexes the uplink reference signal.

The demodulation unit 1043 performs Inverse Discrete Fourier Transform (IDFT) of PUSCH, acquires modulation symbols, and demodulates, for each of the modulation symbols of PUCCH and PUSCH, a reception signal in compliance with a predetermined modulation scheme, such as BPSK, QPSK, 16QAM, 64QAM, and 256QAM, or in compliance with a modulation scheme that the base station apparatus 1A has notified to the terminal apparatus 2A in advance by using the uplink grant.

The decoding unit 1044 decodes the coded bits of PUCCH and PUSCH that have been demodulated, at a coding rate, in compliance with a predetermined coding scheme, that is predetermined or notified from the base station apparatus 1A to the terminal apparatus 2A in advance by using the uplink grant, and outputs the decoded uplink data and uplink control information to the higher layer processing unit 101. In a case that PUSCH is retransmitted, the decoding unit 1044 performs the decoding by using the coded bits that is input from the higher layer processing unit 101 and retained in an HARQ buffer, and the demodulated coded bits.

The measurement unit 106 observes the reception signal, and determines various measurement values such as RSRP/RSRQ/RSSI. The measurement unit 106 determines a received power, a received quality, and a suitable SRS resource index from the SRS transmitted from the terminal apparatus.

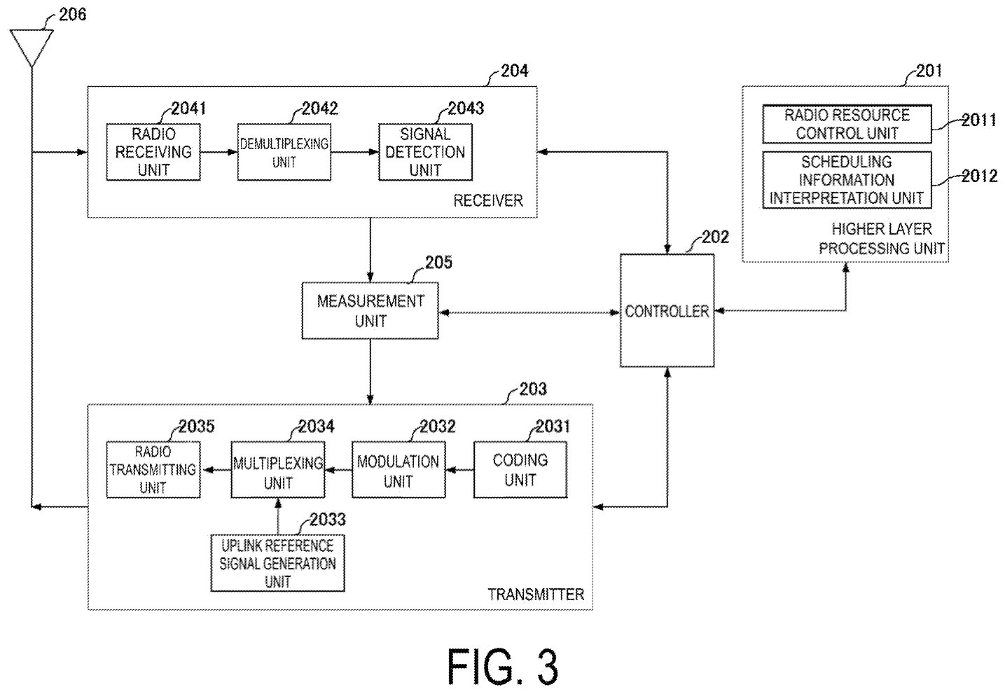

FIG. 3 is a schematic block diagram illustrating a configuration of the terminal apparatus 2A according to the present embodiment. As illustrated in FIG. 3, the terminal apparatus 2A includes a higher layer processing unit (higher layer processing step) 201, a controller (controlling step) 202, a transmitter (transmitting step) 203, a receiver (receiving step) 204, a measurement unit (measuring step) 205, and a transmit and/or receive antenna 206. The higher layer processing unit 201 includes a radio resource control unit (radio resource controlling stop) 2011 and a scheduling information interpretation unit (scheduling information interpreting step) 2012. The transmitter 203 includes a coding unit (coding step) 2031, a modulation unit (modulating step) 2032, an uplink reference signal generation unit (uplink reference signal generating step) 2033, a multiplexing unit (multiplexing step) 2034, and a radio transmitting unit (radio transmitting step) 2035. The receiver 204 includes a radio receiving unit (radio receiving step) 2041, a demultiplexing unit (demultiplexing step) 2042, and a signal detection unit (signal detecting step) 2043.

The higher layer processing unit 201 outputs, to the transmitter 203, the uplink data (the transport block) generated by a user operation or the like. The higher layer processing unit 201 performs processing of the Medium Access Control (MAC) layer, the Packet Data Convergence Protocol (PDCP) layer, the Radio Link Control (RLC) layer, and the Radio Resource Control (RRC) layer.

The higher layer processing unit 201 outputs, to the transmitter 203, information for indicating a function of the terminal apparatus 2A supported by the terminal apparatus 2A.

The radio resource control unit 2011 manages various configuration information of the terminal apparatuses 2A. Furthermore, the radio resource control unit 2011 generates information to be mapped to each uplink channel, and outputs the generated information to the transmitter 203.

The radio resource control unit 2011 acquires configuration information transmitted from the base station apparatus 1A, and outputs the acquired information to the controller 202.

The scheduling information interpretation unit 2012 interprets the downlink control information received through the receiver 204, and determines scheduling information. The scheduling information interpretation unit 2012 generates control information in order to control the receiver 204 and the transmitter 203 in accordance with the scheduling information, and outputs the generated information to the controller 202.

Based on the information input from the higher layer processing unit 201, the controller 202 generates a control signal for controlling the receiver 204, the measurement unit 205, and the transmitter 203. The controller 202 outputs the generated control signal to the receiver 204, the measurement unit 205, and the transmitter 203 to control the receiver 204 and the transmitter 203.

The controller 202 controls the transmitter 203 so as to transmit the CSI/RSRP/RSRQ/RSSI generated by the measurement unit 205 to the base station apparatus 1A.

In accordance with the control signal input from the controller 202, the receiver 204 demultiplexes, demodulates, and decodes a reception signal received from the base station apparatus 1A through the transmit and/or receive antenna 206, and outputs the resulting information to the higher layer processing unit 201.

The radio receiving unit 2041 converts, by down-converting, a downlink signal received through the transmit and/or receive antenna 206 into a baseband signal, removes unnecessary frequency components, controls the amplification level in such a manner as to suitably maintain a signal level, performs orthogonal demodulation based on an in-phase component and an orthogonal component of the received signal, and converts the resulting orthogonally-demodulated analog signal into a digital signal.

The radio receiving unit 2041 removes a portion corresponding to CP from the digital signal resulting from the conversion, performs fast Fourier transform of the signal from which the CP has been removed, and extracts a signal in the frequency domain.

The demultiplexing unit 2042 demultiplexes the extracted signal into PHICH, PDCCH, EPDCCH, PDSCH, and the downlink reference signal. Furthermore, the demultiplexing unit 2042 performs channel compensation for PHICH, PDCCH, and EPDCCH based on a channel estimation value of a desired signal obtained from channel measurement, detects downlink control information, and outputs the detected downlink control information to the controller 202. The controller 202 outputs PDSCH and the channel estimation value of the desired signal to the signal detection unit 2043.

The signal detection unit 2043, by using PDSCH and the channel estimation value, demodulates and decodes a signal, and outputs the decoded signal to the higher layer processing unit 201.

The measurement unit 205 performs various measurements such as a CSI measurement, a Radio Resource Management (RRM) measurement, a Radio Link Monitoring (RLM) measurement, and the like, and determines the CSI/RSRP/RSRQ/RSSI and the like.

The transmitter 203 generates an uplink reference signal in accordance with the control signal input from the controller 202, codes and modulates the uplink data (the transport block) input from the higher layer processing unit 201, multiplexes PUCCH, PUSCH, and the generated uplink reference signal, and transmits a signal resulting from the multiplexing to the base station apparatus 1A through the transmit and/or receive antenna 206.

The coding unit 2031 codes the uplink control information or the uplink data input from the higher layer processing unit 201 in compliance with a coding scheme such as convolutional coding, block coding, LDPC coding, and Polar coding.

The modulation unit 2032 modulates the coded bits input from the coding unit 2031, in compliance with a modulation scheme, such as BPSK, QPSK, 16QAM, or 64QAM, that is notified by using the downlink control information, or in compliance with a modulation scheme predetermined for each channel. The modulation unit 2032 may include a precoding function. The precoding function is a function of converting a modulated signal by a prescribed mathematical formula, and thus may include a function of performing a discrete Fourier transform process on a modulated signal vector as an example. This precoding function may be enabled/disabled by the controller 202. The enabling/disabling of the precoding function may be configured by a control signal transmitted from the base station apparatus 1A, for example, downlink control signals, RRC information, and the like.

The uplink reference signal generation unit 2033 generates a sequence that is determined according to a predetermined rule (formula), based on a physical cell identity (PCI, also referred to as a cell ID or the like) for identifying the base station apparatus 1A, a bandwidth in which the uplink reference signal is mapped, a cyclic shift notified by using the uplink grant, a parameter value for generation of a DMRS sequence, and the like.

The multiplexing unit 2034 multiplexes PUCCH and PUSCH signals and the generated uplink reference signal for each transmit antenna port. To be more specific, the multiplexing unit 2034 maps the PUCCH and PUSCH signals and the generated uplink reference signal to resource elements for each transmit antenna port. The multiplexing unit 2034 may multiplex the output signals of the modulation unit 2032 by one or more units, such as a resource block unit, an OFDM symbol unit, a subcarrier unit, a sampling rate unit, and the like by at least one of the control from the controller 202 and the measurement result of the measurement unit 205.

The radio transmitting unit 2035 performs Inverse Discrete Fourier Transform (IDFT) or Inverse Fast Fourier Transform (IFFT) on a signal resulting from the multiplexing, performs the modulation of OFDM scheme, generates an OFDM symbol, adds CP to the generated OFDM symbol, generates a baseband digital signal, converts the baseband digital signal into an analog signal, removes unnecessary frequency components, up-converts a result of the removal into a signal of a carrier frequency, performs power amplification, and outputs a final result to the transmit and/or receive antenna 206 for transmission. The transmission start timing is controlled by the controller 202. The transmission start timing may be determined based on the uplink transmission grant included in the downlink control signal transmitted from the base station apparatus 1A and the radio resource information specified along with the uplink transmission grant, or the transmission may start based on the measurement result of the measurement unit 205. The CP added to the OFDM symbol is not limited to one type, but CP with multiple periods may be used. A signal having reduced transmit power, for example, a signal with zero power, may be used instead of CP. A portion of the OFDM symbol may be replaced with a signal having a reduced transmit power. A signal sequence (unique word, UW) known in both the base station apparatus 1A and the terminal apparatus 2A may be used instead of CP.

Note that the terminal apparatus 2A can perform a modulation in a Single-Carrier Frequency-Division Multiple Access (SC-FDMA) scheme using a precoding function, not limited to the OFDM scheme. In performing a modulation in the SC-FDMA scheme, discrete Fourier transform may be used as the precoding process.

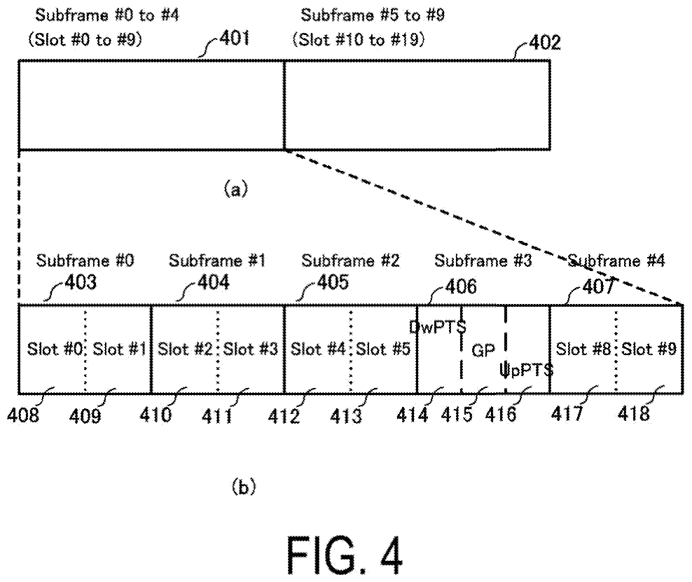

Details of the configuration example of a radio frame used in the uplink are illustrated in FIG. 4. One radio frame includes 10 subframes. The subframe numbers start from 0 and are assigned in sequence to 9. As illustrated in FIG. 4(a), 401 represents five subframes from subframe #0 to subframe #4, and 402 represents five subframes from subframe #5 to subframe #9. One subframe is further represented as two slots. The radio frame may be used in time division multiplexing (TDD) of the downlink and the uplink. In a case of being used in time division multiplexing, one subframe may include a Downlink Pilot Time Slot (DwPTS), which is one downlink reception period, an Uplink Pilot Period (UpPTS), which is one uplink transmission period, and a guard period (Guard Period (GP)), which is configured between the DwPTS and the UpPTS. FIG. 4(b) illustrates an example of the configuration of subframe #0 to subframe #4 during time division multiplexing. Subframe #0 (403) includes slot #0 (408) and slot #1 (409), subframe #1 (404) includes slot #2 and slot #3, and subframe #2 (405) includes slot #4 and slot #5. Subframe #3 (406) includes one DwPTS (414), one GP (415), and one UpPTS (416). Subframe #4 (407) includes slot #8 (417) and slot #9 (418). From subframe #0 (403) to Subframe #2 (405) may be used as the downlink, and subframe #4 (407) may be used as the uplink. The configuration of the subframes is not limited to the configuration illustrated in FIG. 4, and the number of slots included in one radio frame may be a number other than 20, as one example, 10, 40, 80, or the like. The number of slots included in one subframe may be a number other than two, for example, 1, 4, 8, or 16. The configuration of the subframes may be included in the system information broadcasted from the base station apparatus 1A, and in this case, the terminal apparatus 2A may receive the broadcasted system information, and determine a frame configuration to be used for subsequent reception and transmission. In a case that the base station apparatus 1A uses multiple frequency channels, different frame configurations may be configured for each frequency channel. The base station apparatus 1A may configure different frame configurations for a portion of the system band. Other than the broadcasted system information, the frame configuration may be included in control information individually transmitted for each terminal apparatus 2A.

The terminal apparatus 2A receives the information related to the frame configuration by the system information or the control information transmitted from the base station apparatus 1A, and can determine whether a segment corresponding to a subframe or a slot included in the radio frame is used as an uplink transmission. In a case that the DwPTS and the UpPTS is configured, the information indicating which subframe of the subframes included in the radio frame is configured with the DwPTS and UpPTS may be included in the system information or the control information transmitted from the base station apparatus 1A. Information representing a period of the DwPTS and a period of the UpPTS to be configured in one subframe may be included in the information.

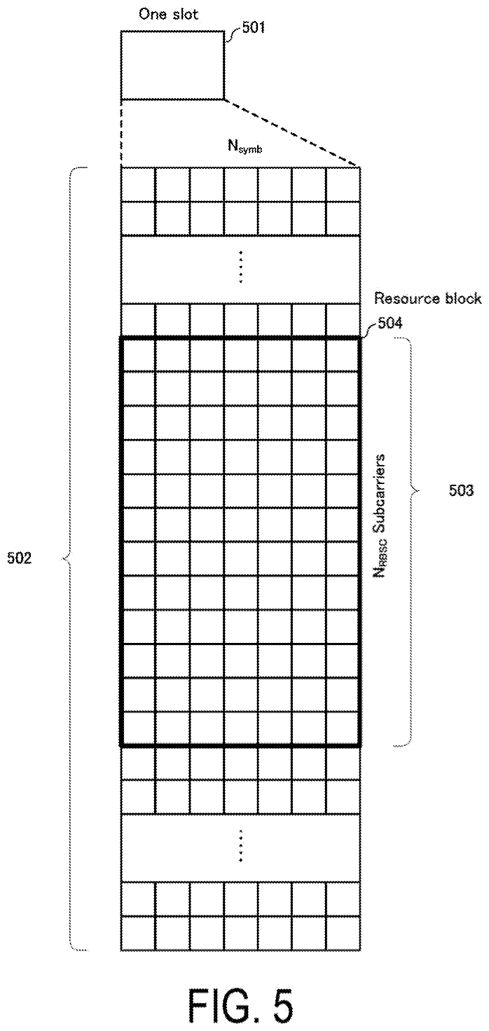

Next, an example of a configuration of slots included in a radio frame will be described using FIG. 5. Slot 501 includes a prescribed number Nymb of OFDM signals. FIG. 5 illustrates an example in which N_{symb} is seven. The subcarriers constituting the OFDM signals are divided into a prescribed number N_{RBSC} (503) of units, and FIG. 5 illustrates an example in which N_{RBSC} (503) is 12. The base station apparatus 1A and the terminal apparatus 2A perform radio resource allocation management on a per allocation unit basis, the allocation unit including the subcarriers N_{RBSC} (503) of N_{RBSC} (503) OFDM signals. This allocation unit is referred to as a resource block. The total number (502) of subcarriers constituting the OFDM signals is the maximum number of resource blocks allocated to the slot*N_{RBSC} or greater. A unit including the OFDM symbol and the prescribed number of subcarriers is defined as a resource grid. The base station apparatus 1A may assign some of multiple resource blocks to one terminal apparatus 2A, or may divide multiple resource blocks and assign each to different terminal apparatuses 2A. The scheme in which multiple resource blocks are divided and allocated to different terminal apparatuses 2A may be referred to as OFDM frequency division multiple access (OFDM-FDMA/OFDMA).

In a case that one of the cells used by the base station apparatus 1A/terminal apparatus 2A is the PCell of a licensed band and communicates with at least one SCell operating in an unlicensed band in carrier aggregation, or in a case of communicating in dual connectivity in which a master cell group communicates in a licensed band and a secondary cell group communicates in an unlicensed band, and in a case of the terminal apparatus 2A is allowed to perform the uplink transmission by the DCI transmitted in the licensed band or the unlicensed band from the base station apparatus 1A, the terminal apparatus 2A can perform the uplink communication by using the radio resources of the unlicensed band allocated simultaneously with the permission. In a case that the terminal apparatus 2A is indicated to perform autonomous transmission from the base station apparatus 1A, carrier sense may be performed in an unlicensed band cell, and the terminal apparatus 2A may perform the uplink transmission by using the radio resource configured for autonomous transmission.

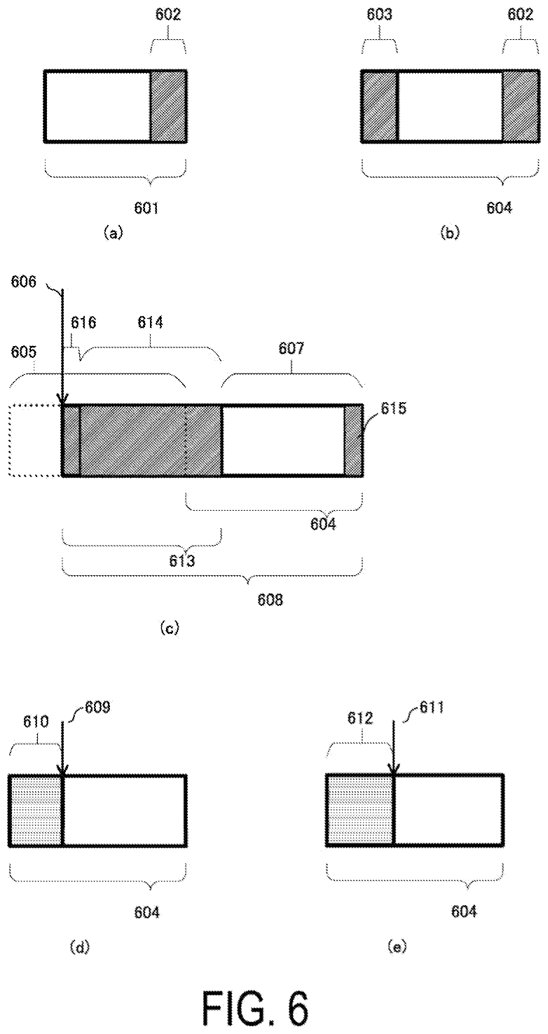

In a case of performing autonomous transmission, the terminal apparatus 2A may perform carrier sense prior to transmission and initiate transmission. The period of time during which the carrier sense is performed is required to be a predetermined period of time or greater than or equal to the period of time. The terminal apparatus 2A may initiate the transmission after determining that the received power during the performance of the carrier sense is less than or equal to a certain value, in other words, the channel for transmission is idle. In a case of performing this autonomous transmission while maintaining the radio frame structure, the transmission start timing may not coincide with a boundary of the OFDM symbol (OFDMA symbol) with CP constituting the resource block. In a case of initiating transmission from other than the boundary of the OFDM symbol while maintaining the structure of the radio frame, a method may be used in which the length of the CP added to the first OFDM symbol is extended and the CP of the extended portion is transmitted in a period of time from the transmission start timing to the next OFDM symbol boundary. The CP to be added in such a method is described using FIG. 6.

FIG. 6(a) illustrates an OFDM signal before CP is added. 601 is an OFDM signal before CP is added, and 602, which is a portion of the OFDM signal, is added as CP. The OFDM signal after CP is added is illustrated in FIG. 6(b). 603 is the added CP, and an entire OFDM symbol 604 with the CP added corresponds to the OFDM symbol illustrated in FIG. 5. FIG. 6(c) illustrates an example of starting transmission at a timing other than a resource grid boundary. In a case that transmission is started at a timing 606 other than a boundary of the OFDM symbol 605, an extended length of CP (613) is added. This extended CP (613) uses an OFDM symbol (607) before CP is added, similar to the OFDM symbol illustrated in FIG. 6(b). In this example, the extended CP (613) is longer than the OFDM symbol (607) before the CP is added, and thus includes a portion (614) using the OFDM symbol (607) before the CP is added and a portion (615) of the OFDM symbol (607) before the CP is added, and the OFDM symbol before the CP is added is repeated. As a result, the OFDM symbol (608) in which the CP of the OFDM symbol 604 illustrated in FIG. 6(b) is extended is transmitted from the transmission start timing 606.

In a case that the transmission method illustrated in FIG. 6(c) is used, transmission efficiency decreases because only CP is transmitted and data is not transmitted in the resource grid segment 605. In the present embodiment, in addition to the method illustrated in FIG. 6(c), a method is disclosed in which, in a case a transmission is started at a timing other than an OFDM symbol boundary, the transmit power of a portion of the OFDM symbol is reduced, as an example, an OFDM symbol in which a portion of the OFDM symbol has been replaced with zeros is used.

FIG. 6(d) illustrates a symbol in which a portion of the OFDM symbol is replaced with zeros. 604 indicates the length of the OFDM symbol with CP illustrated in FIG. 6(b). 609 illustrates an example of a transmission start timing other than an OFDM symbol boundary, and the segment 610 from the beginning of the OFDM symbol to the transmission start timing 609 is replaced with zeros to transmit. As a result, without changing the configuration of the resource grid, the transmission start timing is equivalent to transmitting from other than the boundary of the OFDM symbol, that is, the boundary of the resource grid. The segment replaced with zeros may exceed the segment of the CP, and the segment corresponding to the OFDM symbol before adding the CP may be replaced with zeros. An example of a long segment replaced with zeros is illustrated in FIG. 6(e). 604 is a segment equivalent to the OFDM symbol length with the CP illustrated in FIG. 6(b), 611 is an example of a transmission start timing, and 612 indicates a segment replaced with zeros. The segment replaced with zeros may vary and may be selected from several candidates. The candidates for the segment replaced with zeros may be notified in advance from the base station apparatus 1A, or the terminal apparatus 2A may notify the base station apparatus 1A of the candidates of the segment replaced with zeros. The candidates of the segment replaced with zeros may be changed depending on the modulation scheme (OFDM or SC-FDMA). The candidates of the segment replaced with zeros may be changed depending on the frequency band (e.g., the 2.4 GHz band, the 5 GHz band, or the 60 GHz band).

In a case of acquiring a radio medium, that is, acquiring transmission occasions in the radio medium, the terminal apparatus 2A can configure a priority (or configured by the base station apparatus 1A). In a case that the priority is high, the terminal apparatus 2A can shorten a time period for carrier sense, but meanwhile, the terminal apparatus 2A can also shorten the length of the radio medium acquired by the carrier sense. The terminal apparatus 2A according to the present embodiment can configure whether or not to transmit an OFDM symbol in which a portion of the OFDM symbol has been replaced with zeros depending on the priority (channel access priority) in a case of acquiring the radio medium. The terminal apparatus 2A according to the present embodiment can change the candidate for a segment in which a portion of the OFDM symbol is replaced with zeros depending on the priority in a case of acquiring the radio medium.

The part at which the terminal apparatus 2A replaces a portion of the OFDM symbol by 0 is not limited to any part. The OFDM symbol may be replaced with zeros from the beginning of the OFDM symbol with the CP, may be replaced with zeros from the end of the OFDM symbol, or may be replaced with zeros at the intermediate of the OFDM symbol. In a case of a method other than the method of replacing the OFDM symbol by 0 from the beginning of the OFDM symbol with the CP, a similar OFDM symbol to that in a case that the method of replacing the OFDM symbol by 0 from the beginning of the OFDM symbol is used may be transmitted by moving a part where a portion of the OFDM symbol is replaced with zeros to the beginning of the OFDM symbol, and shifting a portion or whole of the portion in which the portion of the OFDM symbol has not been replaced with zeros.

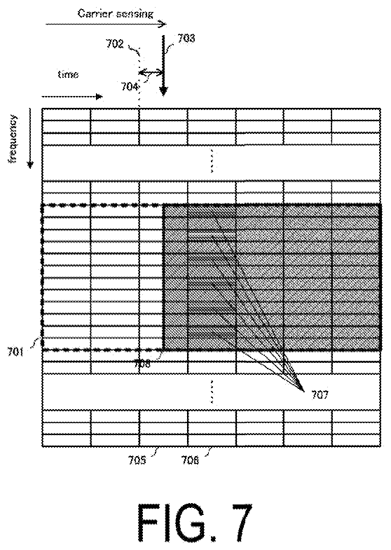

In a case that the transmission method illustrated in FIG. 6(d) or FIG. 6(e) is used, in a case that DMRSs are mapped to OFDM symbols in which a portion of the OFDM symbols is replaced with zeros, the orthogonality between subcarriers of the DMRSs is disrupted and the demodulation performance deteriorates. Thus, the DMRSs are mapped to OFDM symbols other than the OFDM symbols of which a partial segment is replaced with zeros. FIG. 7 illustrates an example of the mapping of the DMRSs. FIG. 7 illustrates an example of starting transmission from other than a boundary of the resource grid using one resource block. 701 is a resource block configured to enable transmission by carrier sense, 702 is one of the boundaries of the resource grid, 703 is the transmission start timing configured by the carrier sense, and 704 is the segment replaced with zeros in the OFDM symbol. In this example, the DMRS 707 is mapped to the OFDM symbol 706 next to the OFDM symbol 705 of which a partial segment has been replaced with zeros. The DMRS 707 is placed in every other subcarrier. In this example, the signal transmitted by the terminal apparatus 2A is a hatched region 708. OFDM symbols after the OFDM symbols 705 of which a partial segment is replaced with zeros are transmitted using the OFDM symbols with the CP added. The OFDM symbols to which the DMRSs are mapped are OFDM symbols next to the OFDM symbols of which a partial segment is replaced with zeros, but the OFDM symbols are not limited thereto. The DMRSs may be mapped to OFDM symbols two OFDM symbols after the OFDM symbols in which a portion is replaced with zeros or the last OFDM symbols in the resource block, or the DMRSs may be mapped to two OFDM symbols including the OFDM symbol next to the OFDM symbol in which a portion is replaced with zeros and the last OFDM symbol of the resource block. In a case that the DMRSs are mapped to multiple OFDM symbols, the number of OFDM symbols for mapping is not limited to two. The DMRS is not necessarily mapped to every other subcarrier. The DMRSs may be mapped to continuous subcarriers, or may be mapped to every multiple subcarriers, such as every two subcarriers, or every three subcarriers. The radio resource used by the terminal apparatus 2A is not limited to a single resource block, and multiple resource blocks may be used. The radio resources used by the terminal apparatus 2A may be notified in advance from the base station apparatus 1A.

Next, an example of a method for demodulating a resource block including an OFDM symbol in which a portion is replaced with zeros as illustrated in FIG. 7, which is transmitted from the terminal apparatus 2A, by the base station apparatus 1A, will be described. The period of the radio frame is synchronized between the base station apparatus 1A and the terminal apparatus 2A, and the base station apparatus 1A can demodulate the OFDM signal transmitted from the terminal apparatus 2A in a case that the terminal apparatus 2A transmits the OFDM signal according to the frame structure. The method for synchronizing the radio frame is not particularly limited, but as in a manner defined in the 3GPP LTE specification, a synchronization signal may be inserted into a portion of a downlink radio frame transmitted from the base station apparatus 1A, and the base station apparatus 1A may transmit information for controlling the timing of the radio frame to the terminal apparatus 2A, based on the signal transmitted based on the synchronization signal from the terminal apparatus 2A. The base station apparatus 1A notifies the terminal apparatus 2A of a radio resource to be used during autonomous transmission. The notification of the radio resource may be notified by the downlink control signal, or may be notified by the RRC information. The base station apparatus 1A may notify the terminal apparatus 2A of a sequence of signals to be used as the reception reference signal.

The base station apparatus 1A receives and stores the signals of one radio frame in the uplink using the radio receiving unit 1041. The variation in the time direction of the received power of the accumulated signals of the radio frame is measured, and it is checked whether there is a segment in which the received power is increased at a timing other than the OFDM symbol boundary. In a case that there is a segment in which the received power is increased at a timing other than the OFDM symbol boundary, the reception processing is performed assuming that the OFDM symbol in which a portion is replaced with zeros is transmitted in the segment in which the received power is increased. The segment replaced with zeros is estimated based on the time at which the received power increases, but in a case that candidates are configured as a segment replaced with zeros, a segment replaced with zeros may be selected from the candidates based on the time at which the received power increases.

The base station apparatus 1A performs the reception processing assuming that a DMRS is mapped to the next OFDM symbol, which is an OFDM symbol in which a portion is replaced with zeros. The base station apparatus 1A removes the CP of the reception signal corresponding to the OFDM symbol to which the DMRS is mapped, performs discrete Fourier transform, and converts a resultant signal to phase amplitude information of each subcarrier constituting the OFDM symbol. The frequency response of the subcarrier to which the DMRS is mapped is acquired, by taking the subcarrier information other than the subcarrier to which the DMRS is mapped as zeros, and dividing by the code used as the DMRS. The inverse discrete Fourier transform of this frequency response determines an impulse response. In a case that the DMRS is mapped to every other subcarrier illustrated in FIG. 7, the signal after the inverse discrete Fourier transform has a form of repeating the impulse response twice, so the signal in the first half of the repetition is used as an impulse response.

Although various methods can be used for a demodulation method of OFDM symbols in which a portion is replaced with zeros, demodulation by compression sensing is performed in the present embodiment. In a case that the number of points in the inverse discrete Fourier transform used in generating the OFDM signal is N, and in a case that the primary modulation signal vector used as the input of the inverse discrete Fourier transform is

x₁=[x₁, . . . ,x_{N}]^{T} [Equation 1]

then the transmission signal after discrete Fourier transform (time domain signal)

s=[s₁, . . . s_{N}]^{T} [Equation 2]

is represented by

s=F^{H}x [Equation 3]

where,

$${F}^{H} = \frac{1}{N} [ \begin{matrix}{W}^{0} & {W}^{0} & {W}^{0} & & {W}^{0} \\ {W}^{0} & {W}^{- 1} & {W}^{- 2} & ⋯ & {W}^{- ( N - 1 )} \\ {W}^{0} & {W}^{- 2} & {W}^{- 4} & & {W}^{- 2 ( N - 1 )} \\ & ⋮ & & ⋱ & ⋮ \\ {W}^{0} & {W}^{- ( N - 1 )} & {W}^{- 2 ( N - 1 )} & ⋯ & {W}^{- {( N - 1 )}^{2}}\end{matrix} ] \qquad [ Equation 4 ]$$

and W is a rotation element and is given by the following equation.

$$W = {e}^{- j \frac{2 π}{N}} \qquad [ Equation 5 ]$$

In a case that the impulse response of the channel is

h=[h₁, . . . ,h_{N}]T [Equation 6]

then the reception signal vector

r=[r₁, . . . ,r_{N}]^{T}[Equation 7]

is given by the following equation as circular convolution of an impulse response h of the channel and the transmission signal vector. Here, noise is not considered in this equation.

r=h·s [Equation 8]

The above equation is expressed using a cyclic matrix H by the following equation.

r=HS=HF^{B}x [Equation 9]

Here,

$$H = [ \begin{matrix}{h}_{1} & {h}_{N} & {h}_{N - 1} & & {h}_{3} & & {h}_{2} \\ {h}_{2} & {h}_{1} & {h}_{N} & ⋯ & & & {h}_{3} \\ {h}_{3} & {h}_{2} & {h}_{1} & & & & \\ & ⋮ & & ⋱ & & ⋮ & \\ {h}_{N - 1} & & & & & & {h}_{N} \\ & & & & ⋯ & & \\ {h}_{N} & {h}_{N - 1} & & & {h}_{2} & & {h}_{1}\end{matrix} ] . \qquad [ Equation 10 ]$$

In a case that the number of samples replaced with zeros in the transmission is M, the signal vector r_{M} in extracting the back (N−M) samples of the OFDM symbols from the reception signal is represented using the matrix

T=[O_{1,M}I_{(N-M),(N-M)}][Equation 11]

by the following equation. Here, O represents a zero matrix and I represents a unit matrix.

r_{M}=Tr=THF^{H}x [Equation 12]

The above equation is represented using

A=THF^{H} [Equation 13]

by the following equation.

τ_{M}=Ax [Equation 14]

Here, in a case that the actual signal presence element (the resource block actually used for transmission of x) of the primary modulation signal vector x is part of N, the primary modulation signal vector x can be reconstructed by applying compressing sensing to r_{M} as x is sparse.

The algorithm of compression sensing is not particularly limited. The algorithm represented by the following equation, which minimizes, for example, one norm used at various places, can be used in the reconstruction of the primary modulation signal vector x.

\hat{x}=argmin∥x∥ᵢ s,t,Ax=τ_{M} [Equation 15]

As an example, an Iterative Hard Tresholding algorithm, a Harl-quadratic regulatization algorithm, or the like can be used.

In the present embodiment, compression sensing is used to demodulate the OFDM signal of which a partial segment is replaced with zeros, but the demodulation method is not limited to this. Other methods may be used, such as encoding the transmission information using a turbo code, and performing turbo equalization processing by the base station apparatus 1A to perform demodulation of the OFDM signal of which a partial segment is replaced with zeros.

Note that, according to the above example, the matrix applied to the primary modulation signal vector is a discrete Fourier transform matrix, but the matrix which the terminal apparatus 2A according to the present embodiment applies to the primary modulation signal vector is not limited to one based on the discrete Fourier transform. The matrix applied to the primary modulation signal vector may be a matrix that projects (transforms) the primary modulation signal vector into other regions (dimensions), i.e., at Equation 14, F^{H} can be replaced with another matrix. For example, the terminal apparatus 2A according to the present embodiment can apply a Walsh matrix to the temporary modulation signal vector.

In a case that the segment replaced with zeros in the OFDM signal to be transmitted is long, the subcarrier interference of the reception signal increases, and the operation desired by the signal reconstruction by the compression sensing may not be performed. Therefore, the segment in which the OFDM signal is replaced with zeros may be limited. This limitation may be determined based on information notified from the base station apparatus 1A, or may be based on a value configured in advance in the terminal apparatus 2A. For example, the segment replaced with zeros may be limited as a segment equal to or less than a numerical value obtained by multiplying the number of points N used in the discrete Fourier transform used in generating the OFDM signal by a certain value α (<1). In a case that the transmission start timing resulting from the carrier sense exceeds the limit of the partial segment replaced with zeros, transmission of OFDM of which a partial segment is replaced with zeros may not be performed, and the OFDM signal with CP may be transmitted from the next resource grid boundary.

In a case that the modulation order of the primary modulation signal is large or in a case that the coding rate is high, it may not be possible to demodulate, in a case that an OFDM symbol of which a partial segment is replaced with zeros is received, the OFDM symbol due to subcarrier interference. Thus, in a case that the modulation order of the primary modulation signal is less than or equal to a prescribed number or the coding rate is less than or equal to a prescribed value, in other words, in a case that the MCS is less than or equal to a prescribed value, the OFDM symbol of which a partial segment is replaced with zeros may be transmitted. The controller 202 may control an OFDM symbol to be transmitted depending on the coding scheme. For example, in a case of a polar code, the controller 202 may control not to perform transmission of OFDM of which a partial segment is replaced with zeros, and, in a case of an LDPC code, the controller 202 may control to transmit an OFDM symbol of which a partial segment is replaced with zeros.

In a case of transmitting the OFDM signal in which a partial segment is replaced with zeros, the controller 202 may control the radio transmitting unit 2035 such that the transmit power is configured to be reduced in the segment replaced with zeros or a portion of the segment replaced with zeros. This can reduce the power consumed by the power amplifier.

In a case that compression sensing is used in demodulating the OFDM signal replaced with zeros, the higher the sparse properties of the transmission signal, the better the performance during demodulation. As such, it may be determined whether the terminal apparatus 2A transmits an OFDM signal of which a partial segment is replaced with zeros during autonomous transmission depending on the number of resource blocks allocated for autonomous transmission for the terminal apparatus 2A. For example, an OFDM signal of which a partial segment is replaced with zeros may be transmitted in a case that the number of resource blocks allocated for autonomous transmission is equal to or less than eight, as 64 resource blocks are assignable in the entire system band. The number of resource blocks that determines whether to transmit an OFDM signal of which a partial segment is replaced with zeros may be a value specific to the terminal apparatus 2A, and may be determined based on information notified from the base station apparatus 1A.

In a case that the terminal apparatus 2A performs the precoding process for performing the discrete Fourier transform processing in order to use the SC-FDMA method, the information bits included in the primary modulation signal are focused on some of the samples of the OFDM symbols that have been precoded. Therefore, in a case that a partial segment of the OFDM symbols is replaced with zeros, the signal reconstruction during demodulation may fail. In order to avoid this, in a case that the discrete Fourier transform is configured as the precoding process of the terminal apparatus 2A, transmission of the OFDM signal of which a partial segment is replaced with zeros may be stopped.

The OFDM symbol of which a partial segment is replaced with zeros by the terminal apparatus 2A has a reduced transmit power per OFDM symbol as compared to a OFDM symbol with normal CP. Therefore, transmit power of the OFDM symbol of which a partial segment is replaced with zeros may be increased more than that of the OFDM symbol with normal CP. The transmit power at this time may be defined by instantaneous power, or may be defined by the length of the segment not replaced with zeros in the OFDM symbol, or the power in a shorter time than the segment not replaced with zeros in the OFDM symbol. The rate of increase in transmit power at that time may be determined based on the segment replaced with zeros and the segment of the entire OFDM symbol with CP. In a case that the segment replaced with zeros is determined from several candidates, there is an advantage that the transmit power of the OFDM symbol of which a partial segment is replaced with zeros is easily estimated precisely because the partial segment replaced with zeros is easily estimated by the base station apparatus 1A.

In order to determine whether or not the technology disclosed as the present embodiment is applicable, the base station apparatus 1A may notify the terminal apparatus 2A of whether or not the OFDM signal in which a partial segment is replaced with zeros can be demodulated. The terminal apparatus 2A may notify the base station apparatus 1A of whether or not the OFDM signal in which a partial segment is replaced with zeros can be transmitted during autonomous transmission.

The above operation of the terminal apparatus and the base station apparatus allows, in a radio system that uses a radio frame, the terminal apparatus to transmit an OFDM signal in which a partial segment is replaced with zeros in a case that the transmission start timing during autonomous transmission by the carrier sense is not the resource grid boundary, thus improving the communication efficiency.

Note that the frequency bands used by the communication apparatuses (base station apparatus and terminal apparatus) according to the present embodiment is not limited to the licensed bands and unlicensed bands described heretofore. Frequency bands intended by the present embodiment include frequency bands called white bands (white space) that are not actually used for a purpose such as preventing interference between frequencies even though the permission of the use is given from a country or a region for specific services (for example, frequency bands that are not used in some regions although assigned for television broadcasting), and shared frequency bands (license shared bands) that are expected to be shared by multiple operators in the future although they have been assigned exclusively to particular operators so far.

A program running on an apparatus according to an aspect of the present invention may serve as a program that controls a Central Processing Unit (CPU) and the like to cause a computer to function in such a manner as to realize the functions of the embodiment according to the aspect of the present invention. Programs or the information handled by the programs are temporarily stored in a volatile memory such as a Random Access Memory (RAM), a non-volatile memory such as a flash memory, a Hard Disk Drive (HDD), or any other storage device system.

Note that a program for realizing the functions of the embodiment according to an aspect of the present invention may be recorded in a computer-readable recording medium. This configuration may be realized by causing a computer system to read the program recorded on the recording medium and to perform the program. It is assumed that the “computer system” refers to a computer system built into the apparatuses, and the computer system includes an operating system and hardware components such as a peripheral device. Furthermore, the “computer-readable recording medium” may be a semiconductor recording medium, an optical recording medium, a magnetic recording medium, a medium dynamically holding the program for a short time, or any other computer readable recording medium.

Furthermore, each functional block or various characteristics of the apparatuses used in the above-described embodiment may be implemented or performed on an electric circuit, for example, an integrated circuit or multiple integrated circuits. An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general purpose processor may be a microprocessor or may be a processor, a controller, a micro-controller, or a state machine of known type, instead. The above-mentioned electric circuit may include a digital circuit, or may include an analog circuit. Furthermore, in a case that with advances in semiconductor technology, a circuit integration technology appears that replaces the present integrated circuits, it is also possible to use a new integrated circuit based on the technology according to one or more aspects of the present invention.

Note that the invention of the present application is not limited to the above-described embodiments. Although apparatuses have been described as an example in the embodiment, the invention of the present application is not limited to these apparatuses, and is applicable to a stationary type or a non-movable type electronic apparatus installed indoors or outdoors such as a terminal apparatus or a communication apparatus, for example, an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope not depart from the gist of the present invention. Furthermore, in the present invention, various modifications are possible within the scope of claims, and embodiments that are made by suitably combining technical means disclosed according to the different embodiments are also included in the technical scope of the present invention. Furthermore, a configuration in which elements described in the respective embodiments and having mutually the same effects, are substituted for one another is also included.

### INDUSTRIAL APPLICABILITY

The present invention can be preferably used for a terminal apparatus, a base station apparatus, and a communication method.

1. A terminal apparatus for communicating with a base station apparatus, the terminal apparatus comprising:
a transmitter configured to transmit an OFDM signal;
a receiver configured to receive a control signal transmitted from the base station apparatus and perform carrier sense; and
a controller configured to control generation of the OFDM signal and a transmission start timing, wherein
the OFDM signal includes any of a first OFDM signal including a signal resulting from inverse discrete Fourier transform and a cyclic prefix (CP) using a portion of the signal resulting from the inverse discrete Fourier transform, and a second OFDM signal obtained by replacing a partial segment of the first OFDM signal with a prescribed number of continuous zeros,
the controller manages a transmission signal with a resource grid of which a unit includes one or more subcarriers and a symbol length of the first OFDM signal, and
in a case that a transmission occasion based on a carrier sense performed by the receiver is different from a boundary of the resource grid, and
in a case that a period between the transmission occasion based on the carrier sense and the boundary of the resource grid is less than or equal to a prescribed time, the second OFDM signal is controlled to be transmitted.

2. The terminal apparatus according to claim 1, wherein
the controller configures a scheme used for coding and a scheme used for modulation,
the scheme used for the coding and the scheme used for the modulation are specified as an MCS,
the transmitter codes and modulates uplink data, based on the MCS for one or more subcarriers included in the first OFDM signal or the second OFDM signal, and
the controller further controls the second OFDM signal to be transmitted in a case that the MCS is lower than a prescribed value.

3. The terminal apparatus according to claim 1, wherein
the partial segment to be replaced with zeros for the second OFDM signal is selected from one or more candidate values.

4. The terminal apparatus according to claim 1, wherein
a transmit power of the second OFDM signal is greater than a transmit power of the first OFDM signal.

5. The terminal apparatus according to claim 1, wherein
the controller is capable of selecting whether a precoding process using a discrete Fourier transform is applied to an input of the inverse discrete Fourier transform, and
in a case that the precoding process is not applied, the second OFDM signal is controlled to be transmitted.

6. The terminal apparatus according to claim 1, wherein
a configuration unit of the resource grid is a resource block,
the transmitter codes and modulates uplink data for one or more subcarriers included in the first OFDM signal or the second OFDM signal, and
the controller controls the second OFDM signal to be transmitted based on the number of resource blocks for transmitting the one or more subcarriers in a frequency domain.

7. The terminal apparatus according to claim 1, wherein
the controller generates control information to be transmitted to the base station apparatus, and
the control information includes information for indicating that the terminal apparatus is capable of generating the second OFDM signal.

8. The terminal apparatus according to claim 1, wherein
in a case that the control information transmitted from the base station apparatus and received by the receiver includes information for indicating that the base station apparatus supports the second OFDM signal,
the controller controls the second OFDM signal to be transmitted.

9. The terminal apparatus according to claim 1, wherein
the transmitter causes a transmit power of a segment which is replaced by zeros in the second OFDM signal to be less than a transmit power of a segment which is not replaced by zeros in the second OFDM signal.

10. A base station apparatus for communicating with a terminal apparatus, the base station apparatus comprising:
a receiver configured to receive a signal transmitted from the terminal apparatus; and
a controller configured to control a control signal, wherein
the terminal apparatus transmits any of a first OFDM signal including a signal resulting from inverse discrete Fourier transform and a cyclic prefix (CP) using a portion of the signal resulting from the inverse discrete Fourier transform, and a second OFDM signal obtained by replacing a partial segment of the first OFDM signal with a prescribed number of continuous zeros,
the receiver receives information for indicating that generation of the second OFDM signal is enabled in a control signal transmitted from the terminal apparatus, and
receives the second OFDM signal transmitted by the terminal apparatus.

11. A communication method used for a terminal apparatus for communicating with a base station apparatus, the communication method comprising:
receiving a control signal transmitted from the base station apparatus;
performing carrier sense; and
controlling generation of an OFDM signal and a transmission start timing, wherein
the generated OFDM signal includes any of a first OFDM signal including a signal resulting from inverse discrete Fourier transform and a cyclic prefix (CP) using a portion of the signal resulting from the inverse discrete Fourier transform, and a second OFDM signal obtained by replacing a partial segment of the first OFDM signal with a prescribed number of continuous zeros,
a transmission signal is managed with a resource grid of which a unit includes one or more subcarriers and an OFDM symbol length including the CP, and
in a case that a transmission occasion based on a result of the carrier sense is different from a boundary of the resource grid, and
in a case that a period between the transmission occasion based on the carrier sense and the boundary of the resource grid is less than or equal to a prescribed time, the second OFDM signal is transmitted.
